(19) United States
(12) Patent Application Publication
(10) Pub. No.: US 2025/0031760 A1
(43) Pub. Date: Jan. 30, 2025

(54) AEROSOL GENERATING DEVICE

(71) Applicant: KT&G CORPORATION, Daejeon (KR)

(72) Inventors: Jueon PARK, Seoul (KR); Taehun KIM, Yongin-si Gyeonggi-do (KR); Hyungjin JUNG, Seoul (KR)

(73) Assignee: KT&G CORPORATION, Daejeon (KR)

(21) Appl. No.: 18/709,371

(22) PCT Filed: Nov. 11, 2022
(86) PCT No.: PCT/KR2022/017783

§ 371 Date: May 10, 2024

(30) Foreign Application Priority Data
Nov. 25, 2021 (KR) 10-2021-0164163

(51) Int. Cl. A24F 40/46; A24F 40/51; H05B 3/22

(52) U.S. Cl. CPC A24F 40/46; A24F 40/51; H05B 3/22

(57) ABSTRACT

An aerosol generating device is provided. The aerosol generating device includes: a body comprising an insertion space; a heater assembly having thermal conductivity and configured to heat the insertion space; a first board installed at the body; and a bridge electrically connecting the heater assembly and the first board, wherein a temperature coefficient of resistance of the bridge is lower than a temperature coefficient of resistance of the heater assembly.

### TECHNICAL FIELD

The present disclosure relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to reduce the amount of heat, which is generated from a heater, conducted to a board (or substrate) connected to the heater.

It is yet another objective of the present disclosure to prevent overheating or failure of a board (or substrate) connected to a heater.

It is yet another objective of the present disclosure to prevent all other parts, except a heater, of an aerosol generating device from becoming hot.

### Solution to Problem

According to one aspect of the subject matter described in this application, an aerosol generating device includes: body comprising an insertion space; a heater assembly having thermal conductivity and configured to heat the insertion space; a first board installed at the body; and a bridge electrically connecting the heater assembly and the first board, wherein a temperature coefficient of resistance of the bridge is lower than a temperature coefficient of resistance of the heater assembly.

### Advantageous Effects of Invention

According to at least one of the embodiments of the present disclosure, the amount of heat, which is generated from a heater, conducted to a board (or substrate) connected to the heater may be reduced.

According to at least one of the embodiments of the present disclosure, overheating or failure of a board (or substrate) connected to a heater may be prevented.

According to at least one of the embodiments of the present disclosure, all other parts, except a heater, of an aerosol generating device may be prevented from becoming hot.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### BRIEF DESCRIPTION OF DRAWINGS

FIGS. 1 to 9 are views illustrating an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

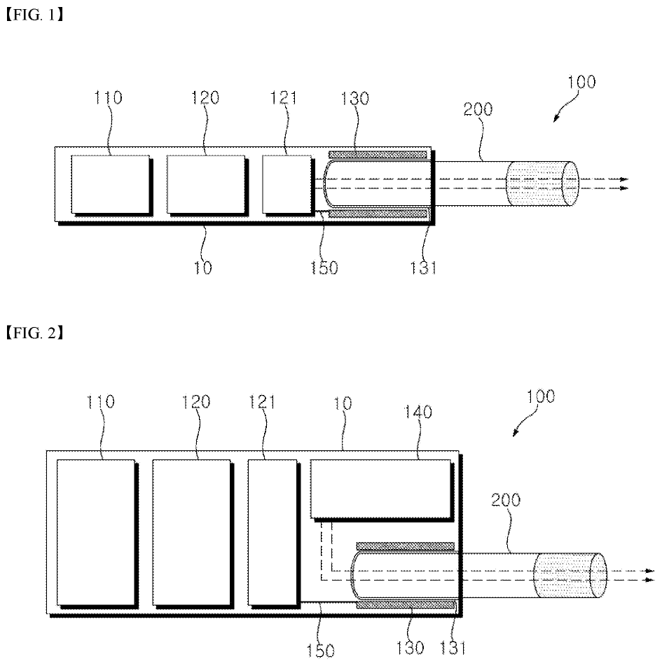

Referring to FIG. 1, an aerosol generating device 100 may include a power supply unit 110, a controller 120, and a heater assembly 130. The power supply unit 110, the controller 120, and the heater assembly 130 may be installed in a body 10. The power supply unit 110, the controller 120, and the heater assembly 130 may be arranged in a line.

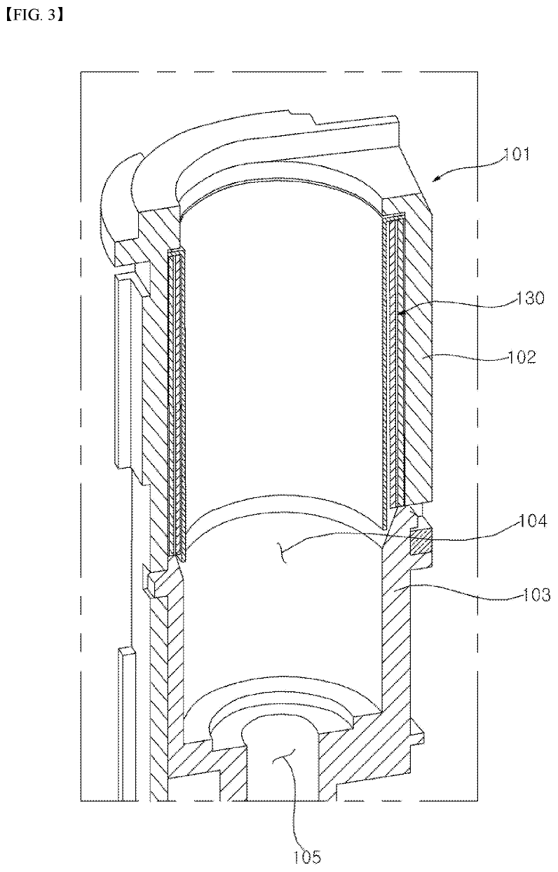

Referring to FIG. 2, the aerosol generating device 100 may further include a cartridge 140. The cartridge 140 may be disposed in parallel with the heater assembly 130. The cartridge 140 may be detachably coupled to the body 10. The internal structure of the aerosol generating device 100 is not limited to those shown in FIGS. 1 and 2, and its arrangement may vary depending on design. For example, the power supply unit 110, the controller 120, the heater assembly 130, and the cartridge 140 may be arranged in a line.

Referring to FIGS. 1 and 2, the aerosol generating device 100 may include an insertion space 104 (see FIG. 3). The insertion space 104 may be open to the outside. The body 10 may provide the insertion space 104.

The heater assembly 130 may heat the insertion space 104. The heater assembly 130 may have thermal conductivity. The heater assembly 130 may be disposed in the vicinity of the insertion space 104. The heater assembly 104 may surround the insertion space 104. A stick 200 may be inserted into the insertion space 104.

The aerosol generating device 100 may operate the heater assembly 130 and/or the cartridge 140 to generate an aerosol. When a user inhales air while holding the stick 200 inserted into the insertion space 104 in his or her mouth, the aerosol generated from the heater assembly 130 and/or the cartridge 140 may pass through the stick 200 to be delivered to the user.

The power supply unit 110 may supply power required to operate the aerosol generating device 100. The power supply unit 110 may supply power to allow the heater assembly 130 to generate heat. The power supply unit 110 may supply power to allow the cartridge 140 to generate an aerosol. The power supply unit 110 may supply power required for the controller 120 to operate. The power supply unit 110 may supply power required to operate a display, a sensor, a motor, and the like installed at the aerosol generating device 100.

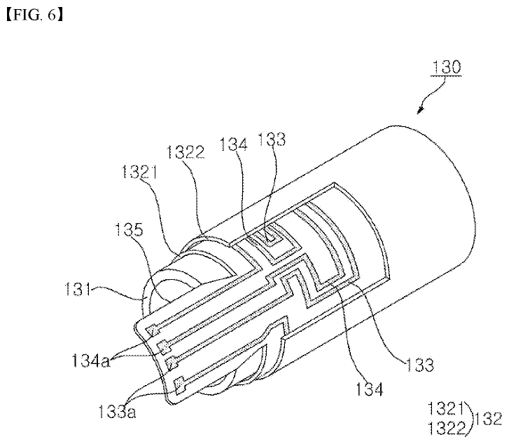

The controller 120 may control the overall operation of the aerosol generating device 100. The controller 120 may control the operation not only of the power supply unit 110, the heater assembly 130, and the cartridge 140, but also of other components included in the aerosol generating device 100. The controller 120 may control power supplied to the heater assembly 130 from the power supply unit 110 based on a temperature measured using a sensor pattern 134 (see FIG. 6). The controller 120 may check the state of each of the components of the aerosol generating device 100 to determine whether the aerosol generating device 100 is in an operable state.

The controller 120 may include at least one processor. The processor may be implemented as an array of multiple logic gates, or may be implemented as a combination of a general-purpose microprocessor and a memory in which a program executable in the microprocessor is stored. It will be apparent to those skilled in the art to which the present disclosure pertains that the processor may also be implemented as any of various other types of hardware.

The heater assembly 130 may generate heat by power supplied from the power supply unit 110. The heater assembly 130 may be an electrically resistive heater. The heater assembly 130 may heat the stick 200 inserted into the insertion space 104 to cause the temperature of an aerosol generating substance in the stick 200 to increase.

The aerosol generating device 100 may include a board (or substrate) 121. The board 121 may be installed in the body 10. A circuit may be printed on the board 121 to transmit an electrical signal. The heater assembly 130 may be electrically connected to the board 121. The power supply unit 110 and the controller 120 may be electrically connected to the board 121. The controller 120 may be mounted on the board 121.

The aerosol generating device 100 may include a bridge 150. The bridge 150 may be installed in the body 10. The heater assembly 130 and the board 121 may be electrically connected to each other by the bridge 150. The bridge 150 may be disposed between the heater assembly 130 and the board 121. The bridge 150 may include an electrically conductive pattern. The bridge 150 may be made of a material having low thermal conductivity. The bridge 150 may be made of a material having lower thermal conductivity than that of the heater assembly 130. The bridge 150 may be made of a material having a lower temperature coefficient of resistance (TCR) than that of the heater assembly 130.

Accordingly, the amount of heat, which is generated from the heater assembly 130, transferred to the board 121 through the bridge 150 may be reduced while transmitting power to the heater assembly 130 through the bridge 150, thereby preventing failure of the board 121 due to overheating. In addition, heating of the surroundings, other than the heater assembly 130, may be prevented.

The cartridge 140 may store a liquid composition therein. The cartridge 140 may heat the liquid composition to generate an aerosol. The cartridge 140 may include a wick for generating the aerosol and a heater. The wick may be supplied with the liquid composition. The heater may heat the wick to generate the aerosol. Air may pass through cartridge 140. The air passing through the cartridge 140 may entrain the aerosol generated from the cartridge 140, and may be delivered to the user through the stick 200. The cartridge 140 may be referred to as a cartomizer or an atomizer.

Referring to FIG. 3, a pipe 101 may be hollow to have an insertion space 104 therein. The insertion space 104 may be open to one side and another side of the pipe 101. One side of the insertion space 104 may be open to the outside. The stick 200 (see FIG. 2) may be inserted into the pipe 101 through the opening of the insertion space 104. The insertion space 104 may have a cylindrical shape elongated up and down or vertically.

The pipe 101 may include a first pipe portion 102 and a second pipe portion 103. The first pipe portion 102 and the second pipe portion 103 may be coupled or assembled to each other to form the pipe 101. The first pipe portion 102 may be disposed on top of the second pipe portion 103. An inner circumferential surface of the first pipe portion 102 may surround an upper portion of the insertion space 104, and an inner circumferential surface of the second pipe portion 103 may surround a lower portion of the insertion space 104. A lower end of the second pipe portion 103 may be open to define an inlet 105. The inlet 105 may be in communication with the insertion space 104. Air may be introduced into the insertion space 104 through the inlet 105.

The heater assembly 130 may be disposed and fixed inside the pipe 101. An upper circumference of the heater assembly 130 may be covered by an upper circumference of the pipe 101. An outer circumferential surface of the heater assembly 130 may be covered by an inner circumferential surface of the pipe 101. The heater assembly 130 may surround at least a portion of the insertion space 104. An inner circumferential surface of the heater assembly 130 may define the insertion space 104. The heater assembly 130 may heat the insertion space 104.

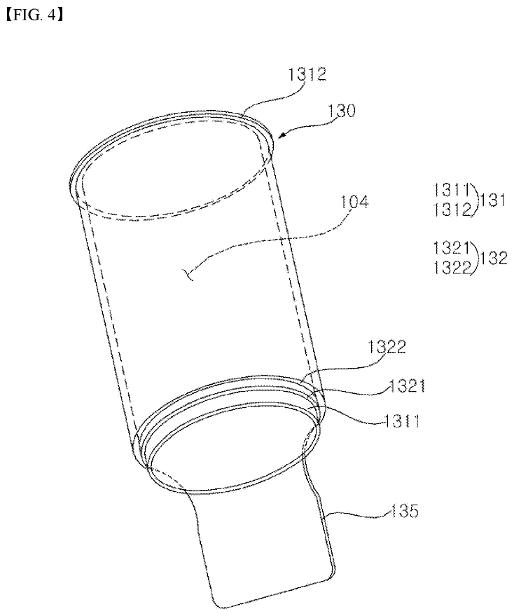

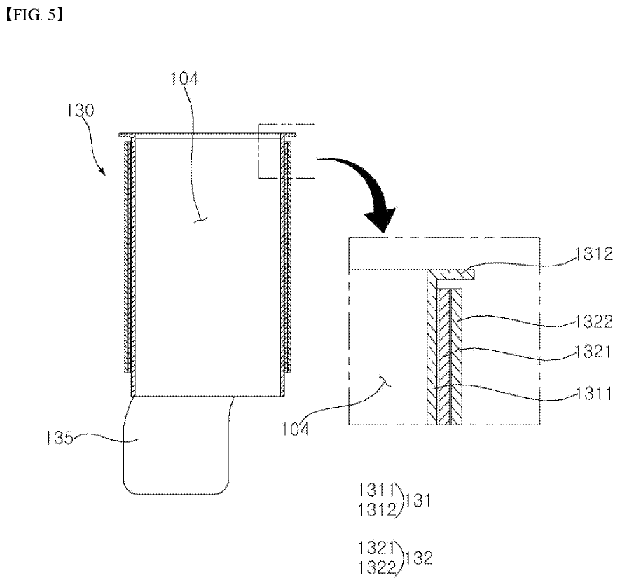

Referring to FIGS. 4 and 5, the heater assembly 130 may include an inner pipe 131 and a layer 132 disposed at an outside of the inner pipe 131.

The inner pipe 131 may have a hollow cylindrical shape. The inner pipe 131 may be open upward and downward. The inner pipe 131 may surround at least a portion of the insertion space 104.

The inner pipe 131 may include a vertical portion 1311 and a rim portion 1312. The vertical portion 1311 may extend to one side in an elongated manner. The vertical portion 1311 may have a hollow cylindrical shape. The vertical portion 1311 may surround at least a portion of the insertion space 104. The rim portion 1312 may extend radially outward from one end of the vertical portion 1311. The rim portion 1312 may extend along a circumference of the vertical portion 1311.

The layer 132 may have a hollow cylindrical shape. The layer 132 may be coupled to surround an outer circumferential surface of the vertical portion 1311. One end of the layer 132 may be disposed adjacent to the rim portion 1312. The rim portion 1312 may prevent the one end of the layer 132 from being separated upward from the inner pipe 131.

The layer 132 may include a first layer 1321 and a second layer 1322. The first layer 1321 and the second layer 1322 may be coupled to each other in an overlapping manner. The first layer 1321 and the second layer 1322 may be flexible. The first layer 1321 may be coupled to surround the outer circumferential surface of the vertical portion 1311. The second layer 1322 may be coupled to surround an outer circumferential surface of the first layer 1321. The first layer 1321 may be disposed between the vertical portion 1311 and the second layer 1322.

FIG. 6 is a cutaway view of the second layer 1322. Referring to FIG. 6, the inner pipe 131 may be made of a thermally conductive base material. The inner pipe 131 may be made of a conductor or an insulator, and may be made of various suitable materials having excellent thermal conductivity. The inner pipe 131 may have an appropriate strength to maintain the shape of the insertion space 104 in which the stick 200 (see FIG. 2) is received, and may have an appropriate thickness to effectively transfer heat from a heating pattern 133.

The first layer 1321 may cover an inside of both the heating pattern 133 and the sensor pattern 134. The first layer 1321 may have an electrical insulation property. The first layer 1321 may have heat resistance enough to withstand heat generated from the heating pattern 133. The first layer 1321 may be made of paper, glass, ceramic, or coated metal. The first layer 1321 may be made of various suitable materials, and is not limited to the examples described above.

The second layer 1322 may cover an outside of both the heating pattern 133 and the sensor pattern 134. The second layer 1322 may have an electrical insulation property. The second layer 1322 may have heat resistance enough to withstand heat generated from the heating pattern 133. The second layer 1322 may have a thermal insulation property. The second layer 1322 may reduce the loss of heat emitted from the heater assembly 130 to the outside.

The heater assembly 130 may include the heating pattern 133. The heating pattern 133 may be integrally printed on the first layer 1321. The heating pattern 133 may be formed between the first layer 1321 and the second layer 1322. The heating pattern 133 may be implemented using an electrically resistive element. As power supplied from the power supply unit 110 causes a current to flow through an electrically resistive heating element, the electrically resistive heating element may generate heat. The heating pattern 133 may be made of aluminum, tungsten, gold, platinum, silver, copper, nickel, palladium, or a combination thereof. The heating pattern 133 may include an alloy, and is not limited to the examples described above. A resistance value of the heating pattern 133 may be variously set according to the constituent material, length, width, thickness, or pattern of an electrically resistive element.

The heating pattern 133 may be made of a material having a low temperature coefficient of resistance. When the temperature coefficient of resistance is low, power loss during heating may be reduced, and the efficiency of heat transfer may be increased (high).

For example, the heating pattern 133 may be Constantan. Constantan may be an alloy containing approximately 55% copper and approximately 45% nickel. The temperature coefficient of resistance of Constantan is 0.000008, which can converge to zero.

Accordingly, the efficiency of heat transfer from the heated heating pattern 133 to the insertion space 104 may be high.

The heater assembly 130 may include the sensor pattern 134. The sensor pattern 134, together with the heating pattern 133, may be integrally printed on the first layer 1321. The sensor pattern 134 may be disposed between the first layer 1321 and the second layer 1322. The sensor pattern 134 may be formed by printing a resistor having a temperature coefficient of resistance. The sensor pattern 134 may be formed at a portion or space between the heating pattern 133 to be adjacent to the heating pattern 133.

The sensor pattern 134 may be made of at least one material among ceramic, semiconductor, metal, and carbon. Like the heating pattern 133, the sensor pattern 134 may be made of an electrically resistive element or an electrically conductive element.

The electrical resistance of a resistor of the sensor pattern 134 may vary depending on temperature. A current may be made to flow on the resistor of the sensor pattern 134 to measure a change in voltage value to thereby derive a change in resistance. Accordingly, by measuring a change in electrical resistance of the sensor pattern 134 due to a temperature change, the temperature of the heater assembly 130 may be measured. However, the present disclosure is not limited thereto, and the change in the resistance may also be derived by applying a voltage on the resistor of the sensor pattern 134 and measuring a change in current value.

A first terminal 133a may be provided at an end (or tip) of the heating pattern 133. The heating pattern 133 and the power supply unit 110 may be electrically connected to each other by the first terminal 133a. The first terminal 133a may correspond to an electrical connection terminal that provides power, which is supplied from the power supply unit 110, to the heating pattern 133. The first terminal 133a may be exposed to the outside from the heater assembly 130.

A second terminal 134a may be provided at an end (or tip) of the sensor pattern 134. The sensor pattern 134 and the power supply unit 110 may be electrically connected to each other by the second terminal 134a. The second terminal 134a may correspond to an electrical connection terminal that provides power, which is supplied from the power supply unit 110, to the sensor pattern 134. The second terminal 134a may be exposed to the outside from the heater assembly 130.

A terminal portion 135 may extend to one side from the layer 132. The terminal portion 135 may be exposed from the layer 132. The heating pattern 133 may extend from the layer 132 to the terminal portion 135, so as to be printed on the terminal portion 135. As the first terminal 133a is provided at the end of the heating pattern 133, the first terminal 133a may be disposed at the terminal portion 135. The sensor pattern 134 may extend from the layer 132 to the terminal portion 135, so as to be printed on the terminal portion 135. As the second terminal 134a is provided at the end of the sensor pattern 134, the second terminal 134a may be disposed at the terminal portion 135.

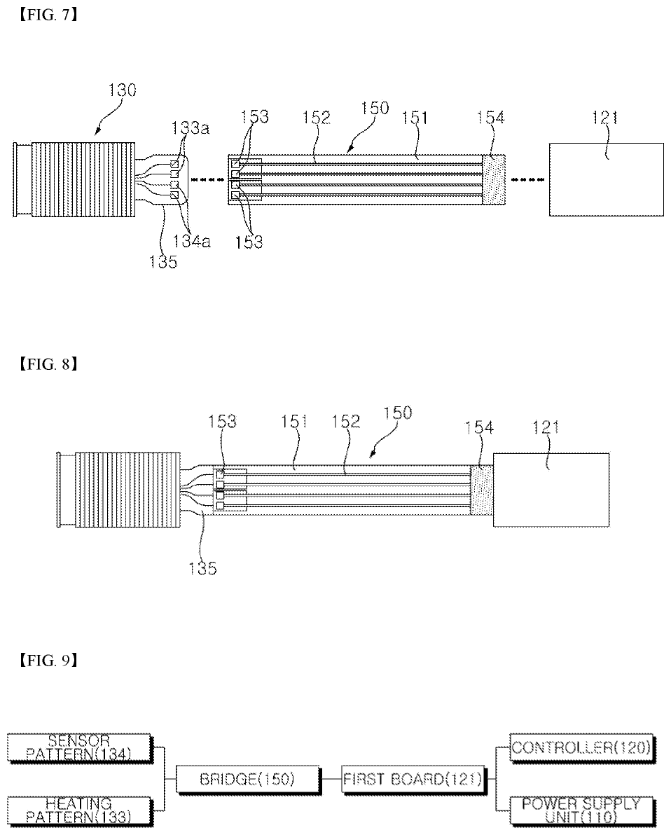

Referring to FIGS. 7 to 9, the aerosol generating device 100 may include a first board 121. The first board 121 may be referred to as a first substrate 121. The first board 121 may transmit an electrical signal to control the operation of various components. A circuit pattern for transmitting the electrical signal may be formed on the first board 121. The first board 121 may be electrically connected to the power supply unit 110 and the controller 120. The controller 120 may be mounted on the first board 121. The first board 121 may be referred to as a main board 121.

The aerosol generating device 100 may include the bridge 150. The heater assembly 130 and the first board 121 may be electrically connected to each other by the bridge 150. One end of the bridge 150 may be coupled to the terminal portion 135 of the heater assembly 130. Another end of the bridge 150 may be coupled to the first board 121.

The bridge 150 may include a second board 151. The second board 151 may be referred to as a second substrate 151. The second board 151 may be referred to as a connection board 151. The second board 151 may extend from the heater assembly 130 to the first board 121. The second board 151 may be configured as a flexible printed circuit board (FPCB). The second board 151 may be easily installed in the aerosol generating device 100 due to its flexibility.

The bridge 150 may include a connection pattern 152 printed on the second board 151. The connection pattern 152 may extend from one end to another end of the second board 151. The connection pattern 152 may be made of an electrically conductive element. The connection pattern 152 may be provided in plurality to correspond to the first terminal 133a and the second terminal 134a. The connection pattern 152 may be covered with a layer having electrical and thermal insulation properties.

The bridge 150 may include a connection terminal 153. The connection terminal 153 may be disposed at one end of the bridge 150. The connection terminal 153 may be provided at one end of each of the plurality of connection patterns 152. The connection terminal 153 may be provided in plurality to correspond to the first terminal 133a and the second terminal 134a. The connection terminal 153 may be in contact with the first terminal 133a and the second terminal 134a of the terminal portion 135 to be electrically connected to the first terminal 133a and the second terminal 134a. The connection terminal 153 may be coupled or joined to the first terminal 133a and the second terminal 134a. For example, the connection terminal 153 may be joined to the first terminal 133a and the second terminal 134a by soldering.

The bridge 150 may include a connector 154. The connector 154 may be provided at another end of the connection pattern 152. The connector 154 may be disposed opposite the connection terminal 153 with respect to the connection pattern 152. As the connector 154 is coupled to the first board 121, the connection pattern 152 of the bridge 150 and the first board 121 may be coupled to each other.

Accordingly, the first board 121 and the heater assembly 130 may be electrically connected to each other. The power supply unit 110 connected to the first board 121 may supply power to the heater assembly 130 through the bridge 150.

The heater assembly 130 may be made of a material having a lower temperature coefficient of resistance than that of the bridge 150. The heating pattern 133 may be made of a material having a lower temperature coefficient of resistance than that of the connection pattern 152 of the bridge 150.

For example, the heating pattern 133 may be Constantan with a temperature coefficient of resistance of 0.000008, which can converge to zero, and the bridge 150 may be nickel with a temperature coefficient of resistance of 0.006 or copper with a temperature coefficient of resistance of 0.00386. The material of the heating pattern 133 and the connection pattern 153 of the bridge 150 are not limited to the above description. The lower the temperature coefficient of resistance, the higher the heat transfer efficiency, thereby reducing loss of available power. In addition, as the temperature coefficient of resistance is lower, the rate of increase in temperature of a heating element to which power is applied may be increased.

The connection pattern 152 may have low thermal conductivity. The bridge 150 may be made of a material having lower thermal conductivity than that of the heater assembly 130. The connection pattern 152 may be made of a material having lower thermal conductivity than that of the heating pattern 133 of the heater assembly 130. The amount of heat generation of the connection pattern 152 may be less than the amount of heat generation of the heating pattern 133. The connection pattern 152 may be covered with a layer having a thermal insulation property.

Accordingly, the amount of heat, which is generated from the heater assembly 130, conducted to the first board 121 through the bridge 150 may be reduced, and failure of the first board 121 due to overheating may be prevented. In addition, all other parts except the heater assembly 130 may be prevented from becoming hot.

Referring to FIGS. 1 to 9, an aerosol generating device 100 according to one aspect of the present disclosure may include: a body 10 comprising an insertion space 104; a heater assembly 130 having thermal conductivity and configured to heat the insertion space 104; a first board 121 installed at the body 10; and a bridge 150 electrically connecting the heater assembly 130 and the first board 121. A temperature coefficient of resistance of the bridge 150 may be lower than a temperature coefficient of resistance of the heater assembly 130.

According to another aspect of the present disclosure, the heater assembly 130 may include: an inner pipe 131 defining the insertion space 104; a flexible first layer 1321 and a flexible second layer 1322 surrounding the inner pipe 131, and a heating pattern 133 disposed between the first layer 1321 and the second layer 1322, and connected to the bridge 150.

According to another aspect of the present disclosure, the bridge 150 may include: a second board 151 extending between the heater assembly 130 and the first board 121; and a connection pattern 152 printed on the second board 151 and having a lower temperature coefficient of resistance than the heating pattern 133.

According to another aspect of the present disclosure, the heater assembly 130 may further include a first terminal 133a provided at an end of the heating pattern 133. The bridge 150 may include a connection terminal 153 provided at one end of the connection pattern 152 and configured to be electrically connected to the first terminal 133a.

According to another aspect of the present disclosure, the heater assembly 130 may further include a terminal portion 135 extending from the first layer 1321 and the second layer 1322 so as to be exposed from the heater assembly 130, and the first terminal 133a may be disposed at the terminal portion.

According to another aspect of the present disclosure, the heater assembly 130 may further include a sensor pattern 134 formed between the first layer 1321 and the second layer 1322, and disposed adjacent to the heating pattern 133 and configured to sense a temperature of the heater assembly 130.

According to another aspect of the present disclosure, the heater assembly 130 may further include a second terminal 134a provided at an end of the sensor pattern 134 and configured to be electrically connected to the connection terminal 153.

According to another aspect of the present disclosure, the heater assembly 130 may further include a terminal portion 135 extending from the first layer 1321 and the second layer 1322 so as to be exposed from the heater assembly 130, and the first terminal and the second terminal may be disposed at the terminal portion.

According to another aspect of the present disclosure, the heating pattern 133 may be made of Constantan.

According to another aspect of the present disclosure, the second board 151 may be a flexible printed circuit board (FPCB).

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body comprising an insertion space;
a heater assembly having thermal conductivity and configured to heat the insertion space;
a first board installed at the body; and
a bridge electrically connecting the heater assembly and the first board,
wherein a temperature coefficient of resistance of the bridge is lower than a temperature coefficient of resistance of the heater assembly.

2. The aerosol generating device of claim 1, wherein the heater assembly comprises:
an inner pipe defining the insertion space;
a flexible first layer and a flexible second layer surrounding the inner pipe; and
a heating pattern disposed between the first layer and the second layer and connected to the bridge.

3. The aerosol generating device of claim 2, wherein the bridge comprises:
a second board extending between the heater assembly and the first board; and
a connection pattern printed on the second board and having a lower temperature coefficient of resistance than the heating pattern.

4. The aerosol generating device of claim 3, wherein the heater assembly further comprises a first terminal provided at an end of the heating pattern, and
wherein the bridge comprises a connection terminal provided at one end of the connection pattern and configured to be electrically connected to the first terminal.

5. The aerosol generating device of claim 4, wherein the heater assembly further comprises a terminal portion extending from the first layer and the second layer so as to be exposed from the heater assembly, and
wherein the first terminal is disposed at the terminal portion.

6. The aerosol generating device of claim 4, wherein the heater assembly further comprises a sensor pattern formed between the first layer and the second layer, and disposed adjacent to the heating pattern and configured to sense a temperature of the heater assembly.

7. The aerosol generating device of claim 6, wherein the heater assembly further comprises a second terminal provided at an end of the sensor pattern and configured to be electrically connected to the connection terminal.

8. The aerosol generating device of claim 7, wherein the heater assembly further comprises a terminal portion extending from the first layer and the second layer so as to be exposed from the heater assembly, and
wherein the first terminal and the second terminal are disposed at the terminal portion.

9. The aerosol generating device of claim 3, wherein the heating pattern is made of Constantan.

10. The aerosol generating device of claim 3, wherein the second board is a flexible printed circuit board (FPCB).
